(19) United States
(12) Patent Application Publication
(10) Pub. No.: US 2008/0065647 A1
(43) Pub. Date: Mar. 13, 2008

(54) MOBILE TERMINAL

(76) Inventor: Hiroshi HINOHARA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/853,591

(22) Filed: Sep. 11, 2007

(30) Foreign Application Priority Data
Sep. 12, 2006 (JP) 2006-247237
Aug. 27, 2007 (JP) 2007-220251

(51) Int. Cl. G06F 17/30; G06F 15/16

(52) U.S. Cl. 707/10; 358/402; 455/413; 709/206; 707/E17.01

(57) ABSTRACT

A mobile terminal includes a destination specifying unit which is configured to specify a communication destination. A server connection unit is configured to connect the mobile terminal with a history server which manages communication history. A history information acquisition unit is configured to transmit a request to the history server through the server connection unit and to acquire history information having a metadata described in a structured language and containing an update information of a communication history of the communication destination, specified by the destination specifying unit, from the history server through the server connection unit.

### BACKGROUND OF THE INVENTION

1. Field of the Invention

This invention relates to a mobile terminal which is capable of viewing communication records with a customer away from the office of the user.

2. Description of the Related Art

There are many scenes in which a user calls a customer by his mobile terminal, such as a cellular phone, in a place away from the office of the user. In such a case, the user uses an address book function of the mobile terminal. The address book function is enough if the purpose of the user is only to call the customer.

However, in the address book of the mobile terminal according to the related art, only a set of predetermined items of information, such as a customer name, a phone number, a fax number, an e-mail address, etc. are registered. The records of the latest phone calls, faxes or mails exchanged with the customer are not included in the address book, and it is difficult for the user to communicate with the customer based on the contents of the latest exchanges with the customer.

Meanwhile, there is proposed the method of transmitting a communication history of a fax to a personal computer (PC). For example, see Japanese Laid-Open Patent Application No. 2006-054732. Moreover, there is proposed the system which is adapted for sharing records of exchanges, such as phone calls, faxes, and mails, by making use of the groupware, etc.

However, the groupware usually is configured by assuming that the groupware is adapted in cooperation with a personal computer (PC) as a client, and there is a difficulty in adapting the groupware in cooperation with a mobile terminal, such as a cellular phone.

### SUMMARY OF THE INVENTION

According to one aspect of the invention, there is provided an improved mobile terminal in which the above-described problems are eliminated.

According to one aspect of the invention there is provided a mobile terminal which allows the user to view communication records with a customer in a place away from the office of the user.

In an embodiment of the invention which solves or reduces one or more of the above-mentioned problems, there is provided a mobile terminal comprising: a destination specifying unit configured to specify a communication destination; a server connection unit configured to connect the mobile terminal with a history server which manages communication history; and a history information acquisition unit configured to transmit a request to the history server through the server connection unit and to acquire history information having a metadata described in a structured language and containing an update information of a communication history of the communication destination, specified by the destination specifying unit, from the history server through the server connection unit.

The above-mentioned mobile terminal may be arranged so that the mobile terminal further comprises a registration request unit configured to request the history server to register a communication history.

The above-mentioned mobile terminal may be arranged so that the mobile terminal further comprises: a unit configured to display a list of items of the history information acquired from the history server; and a unit configured to transmit a request to the history server in response to an item selected by a user from among the items of the history information in the list, so that detailed information of the history information corresponding to the selected item is acquired from the history server and displayed in the mobile terminal.

The above-mentioned mobile terminal may be arranged so that the mobile terminal further comprises a unit configured to temporarily store call voice data in the mobile terminal.

The above-mentioned mobile terminal may be arranged so that the registration request unit is configured to transmit the temporarily stored call voice data by a multi-part transmission as a part of the communication history being registered by the history server.

In an embodiment of the invention which solves or reduces one or more of the above-mentioned problems, a mail server for use with the above-mentioned mobile terminal may be arranged so that the mail server comprises a mail registration request unit configured to request the history server to register history information of e-mail transmitting and receiving.

In an embodiment of the invention which solves or reduces one or more of the above-mentioned problems, a fax terminal for use with the above-mentioned mobile terminal may be arranged so that the fax terminal comprises a fax registration request unit configured to request the history server to register history information of fax transmitting and receiving.

In an embodiment of the invention which solves or reduces one or more of the above-mentioned problems, there is provided a history server comprising: a request receiving unit configured to receive a request from a terminal; a history information storing unit configured to store, in response to a request for registration of communication history information from the terminal, the history information; and a response transmitting unit configured to transmit, in response to a request for acquisition of communication history information from the terminal, a response having a metadata in which the history information is described in a structured language, to the terminal.

The above-mentioned history server may be arranged so that the history server further comprises: a history database holding history information; a user database holding user information; a destination database holding destination information; and a content database holding a main part of communication data.

The above-mentioned history server may be arranged so that the history server further comprises a unit configured to temporarily store call voice data.

The above-mentioned history server may be arranged so that the history server is provided with a mail server function, and communication history information of the mail server function is registered in the history server.

In an embodiment of the invention which solves or reduces one or more of the above-mentioned problems, there is provided a history viewing management method comprising steps of: specifying a communication destination; connecting a mobile terminal with a history server which manages communication history; transmitting a request to the history server through the connecting step; and acquiring history information having a metadata described in a structured language and containing an update information of a communication history of the communication destination, specified in the specifying step, from the history server through the connecting step.

According to embodiments of the mobile terminal of the invention, the user is allowed to view communication history with a customer in a place away from the office of the user, and the operating activities of the user can be effectively supported by the mobile terminal of the invention.

### BRIEF DESCRIPTION OF THE DRAWINGS

Other objects, features and advantages of the present invention will be apparent from the following detailed description when reading in conjunction with the accompanying drawings.

FIG. 1 is a diagram showing the composition of a history viewing management system in an embodiment of the invention.

FIG. 2 is a diagram showing the composition of a history viewing management system in an embodiment of the invention.

FIG. 3 is a diagram showing the composition of a history viewing management system in an embodiment of the invention.

FIG. 4 is a diagram showing the composition of a mobile terminal in an embodiment of the invention.

FIG. 5 is a diagram showing the example of composition of a mail server.

FIG. 6 is a diagram showing the composition of a fax terminal.

FIG. 7 is a diagram showing the composition of a history server.

FIG. 8 is a diagram showing the composition of an IP phone conversion server.

FIG. 9A, FIG. 9B, FIG. 9C and FIG. 9D are diagrams showing an example of a history database group.

FIG. 10 is a flowchart for explaining the processing when viewing of the address book in the mobile terminal is performed.

FIG. 11A, FIG. 11B, FIG. 11C and FIG. 11D are diagrams showing examples of display screens on the mobile terminal when viewing of the address book is performed.

FIG. 12A, FIG. 12B, FIG. 12C, FIG. 12D, FIG. 12E and FIG. 12F are diagrams showing examples of RSS contained in a request and a response exchanged between the mobile terminal and the history server.

FIG. 13A, FIG. 13B and FIG. 13C are diagrams showing examples of display screens in the mobile terminal when detailed item information is displayed.

FIG. 14 is a flowchart for explaining the processing when a phone call is transmitted or received by the mobile terminal.

FIG. 15 is a diagram showing an example of a display screen on the mobile terminal after a phone call is terminated.

FIG. 16A, FIG. 16B and FIG. 16C are diagrams showing examples of a request and a response exchanged between the mobile terminal and the history server.

FIG. 17A and FIG. 17B are flowcharts for explaining the processing when a fax transmission is performed by a fax terminal and the processing when a fax reception is performed by the fax terminal.

FIG. 18A, FIG. 18B and FIG. 18C are diagrams showing examples of a request and a response exchanged between the fax terminal and the history server.

FIG. 19A and FIG. 19B are diagrams showing examples of display screens in the mobile terminal when a fax distribution is performed.

FIG. 20A and FIG. 20B are flowcharts for explaining the processing when a mail transmission is performed by the mail server and the processing when a mail reception is performed by the mail server.

FIG. 21A, FIG. 21B and FIG. 21C are diagrams showing examples of a request and a response exchanged between the mail server and the history server.

FIG. 22A and FIG. 22B are flowcharts for explaining the processing when a mail transmission is performed by the history server and the processing when a mail reception is performed by the history server.

FIG. 23 is a flowchart for explaining the processing when a history registration request is received by the history server.

### DETAILED DESCRIPTION OF PREFERRED EMBODIMENTS

A description will be given of embodiments of the invention with reference to the accompanying drawings.

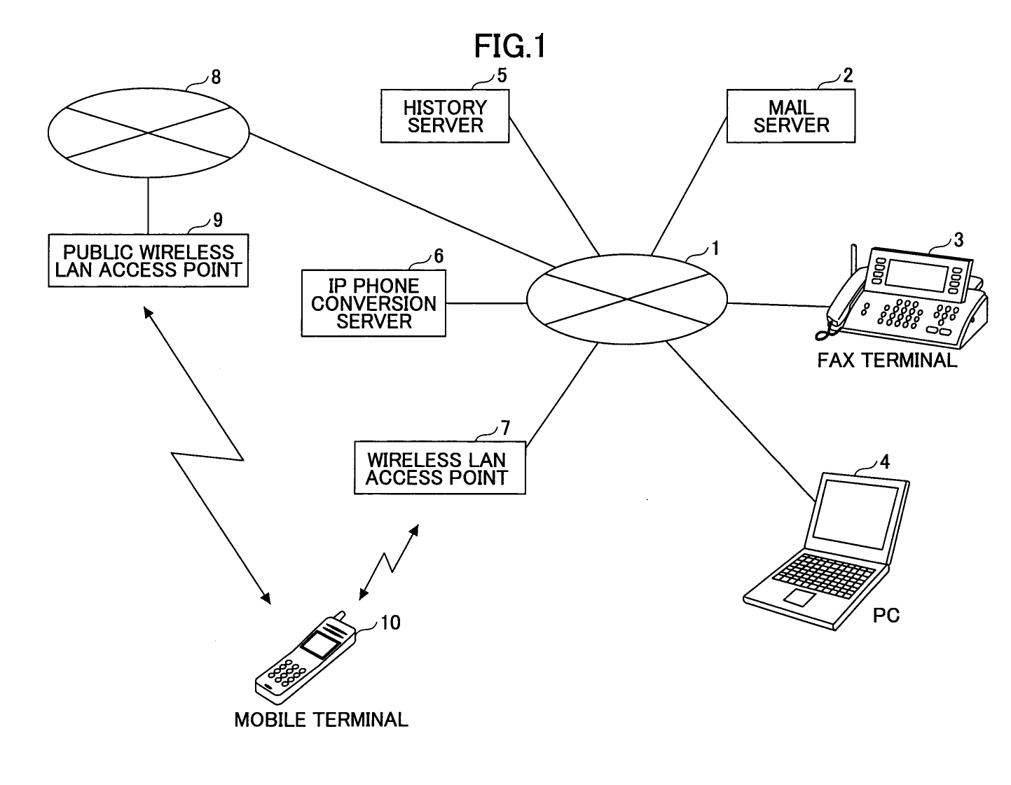

FIG. 1 shows the composition of a history viewing management system in an embodiment of the invention.

In FIG. 1, a network 1 is, for example, the intranet of a company. As shown in FIG. 1, connected with this network 1 are: a mail server 2 which manages e-mail transmitting/receiving: a fax terminal 3 which performs fax transmitting/receiving; a personal computer (PC) 4 on which a user performs the business proceeding; a history server 5 which manages history information of e-mails, faxes and phone calls: an IP phone conversion server 6 which performs transfer of an IP (Internet Protocol) phone call; and a wireless LAN access point 7.

Moreover, the network 1 is connected with the network 8 which is, for example, the Internet. And a public wireless LAN access point 9 is provided on the network 8.

A mobile terminal 10 is a terminal which is owned by a user, and this mobile terminal 10 can be connected with the network 1 via the wireless LAN access point 7, or connected with the network 8 via the public wireless LAN access point 9, so that it can perform a phone call (IP phone) and an e-mail transmitting/receiving.

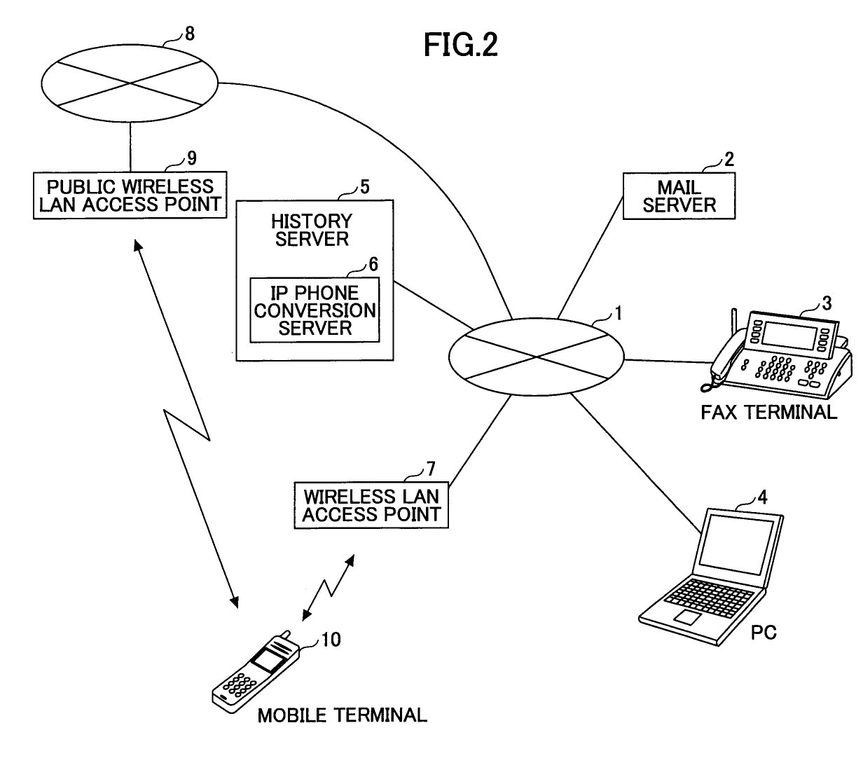

FIG. 2 shows the composition of a history viewing management system in another embodiment of the invention. In this embodiment, the IP phone conversion server 6 shown in FIG. 1 is incorporated into the history server 5. Other composition is the same as that shown in FIG. 1.

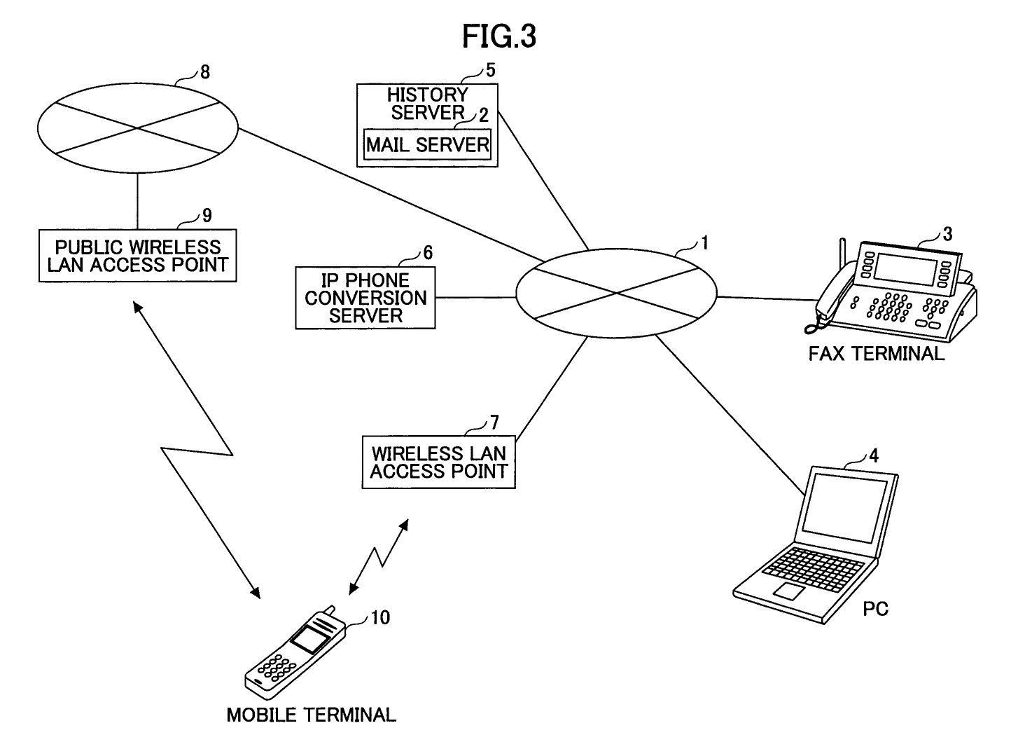

FIG. 3 shows the composition of a history viewing management system in another embodiment of the invention. In this embodiment, the mail server 2 shown in FIG. 1 is incorporated into the history server 5. Other composition is the same as that shown in FIG. 1.

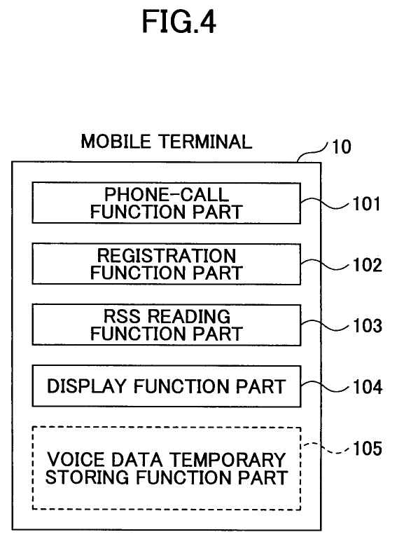

FIG. 4 shows the composition of a mobile terminal 10 in an embodiment of the invention. As shown in FIG. 4, the mobile terminal 10 includes a phone-call function part 101, a registration function part 102, and a RSS reading function part 103. The phone-call function part 101 provides a phone-call function as a telephone. The registration function part 102 provides the function of connecting the mobile terminal 10 with the history server 5 at the time of termination of a phone call, and registering history information in the history server 5. The RSS reading function part 103 provides the function of reading a RSS (RDF (resource description framework) site summary) from the history server 5 in which history information of a phone call, fax, mail, etc. with a customer (communication destination) specified by the user at the time of viewing an address book is described as a metadata in a structured language, and provides the function of reading an RSS from the history server 5 in which the details of an item of history information with the customer specified by the user from among the items of the history list, are described as a metadata in a structured language.

Moreover, the mobile terminal 10 further includes a display function part 104 and a voice data temporary storing function part 105. The display function part 104 provides the function of displaying history information and provides the function of specifying a customer (communication destination) using a display screen interface (to support the display capabilities of the mobile terminal 10). The voice data temporary storing function part 105 provides the function of temporarily storing voice data of a phone call.

Alternatively, the voice data temporary storing function part 105 may be omitted when the voice data accumulation function exists in the IP phone conversion server 6.

FIG. 5 shows the composition of a mail server 2. As shown in FIG. 5, the mail server 2 includes a mail transmitting/receiving function part 21 and a registration function part 22. The mail transmitting/receiving function part 21 provides the function of e-mail transmitting and receiving. The registration function part 22 provides the function of registering history information into the history server 5 every time e-mail transmitting/receiving is performed by the mail server 2. Thus, the history server 5 retains update information of the history information of e-mail transmitting/receiving.

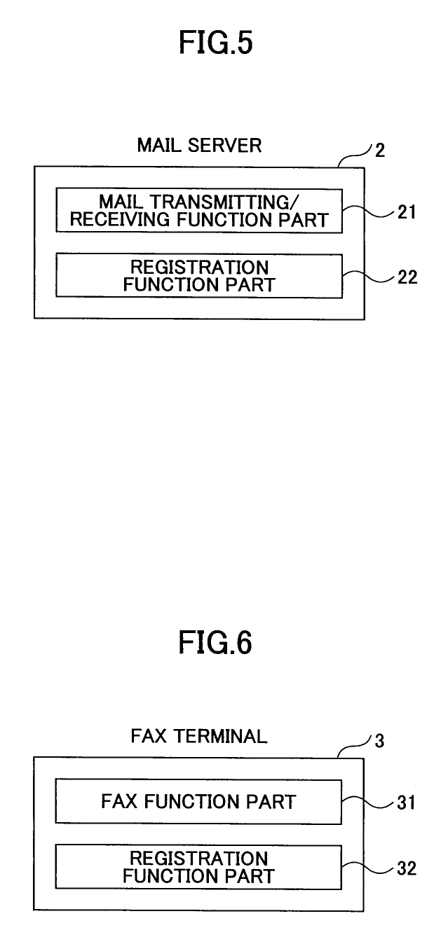

FIG. 6 shows the composition of a fax terminal 3. As shown in FIG. 6, the fax terminal 3 includes a fax function part 31 and a registration function part 32. The fax function part 31 provides the function of fax transmitting and receiving. The registration function part 32 provides the function of registering history information into the history server 5 every time when fax transmitting/receiving is performed by the fax terminal 3. Thus, the history server 5 retains update information of the history information of fax transmitting/receiving.

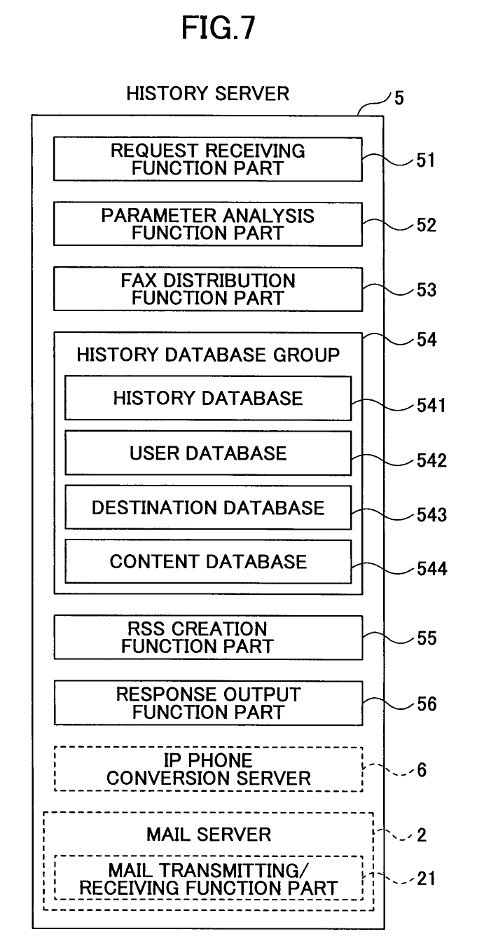

FIG. 7 shows the composition of a history server 5. As shown in FIG. 7, the history server 5 includes a request receiving function part 51, a parameter analysis function part 52, a fax distribution function part 53, and a history database group 54. The request receiving function part 51 provides the function of receiving various kinds of requests (a history-information registration request, a history-information acquisition request, etc.) from any of the mobile terminal 10, the mail server 2, and the fax terminal 3. The parameter analysis function part 52 provides the function of analyzing the parameters contained in a received request. The fax distribution function part 53 provides the functions of requesting to the user distribution of a fax the destination of which cannot be detected and distributing the fax. The history database group 54 includes a history database 541, a user database 542, a destination database 543, and a content database 544.

Moreover, the history server 5 includes a RSS creation function part 55 and a response output function part 56. The RSS creation function part 55 provides the function of creating an RSS which is transmitted to the mobile terminal 10 as a response. The response output function part 56 provides the function of outputting a response to one of various kinds of requests from the mobile terminal 10, the mail server 2 and the fax terminal 3.

In the case of the composition shown in FIG. 2, the IP phone conversion server 6 is provided within the history server 5. In the case of the composition shown in FIG. 3, the mail server 2 in which the mail transmitting/receiving function part 21 is included therein is provided within the history server 5.

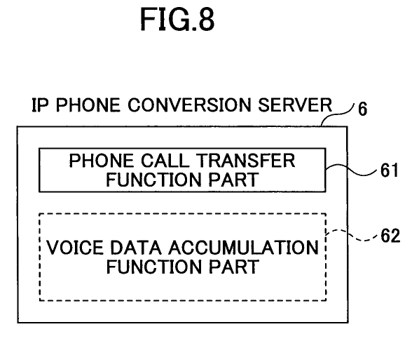

FIG. 8 shows the composition of an IP phone conversion server 6. As shown in FIG. 8, the IP phone conversion server 6 includes a phone call transfer function part 61 which provides the function of transferring an IP phone call. The IP phone conversion server 6 includes a voice data accumulation function part 62 which provides the function of accumulating voice data of phone calls.

Alternatively, the voice data accumulation function part 62 may be omitted from the IP phone conversion server 6.

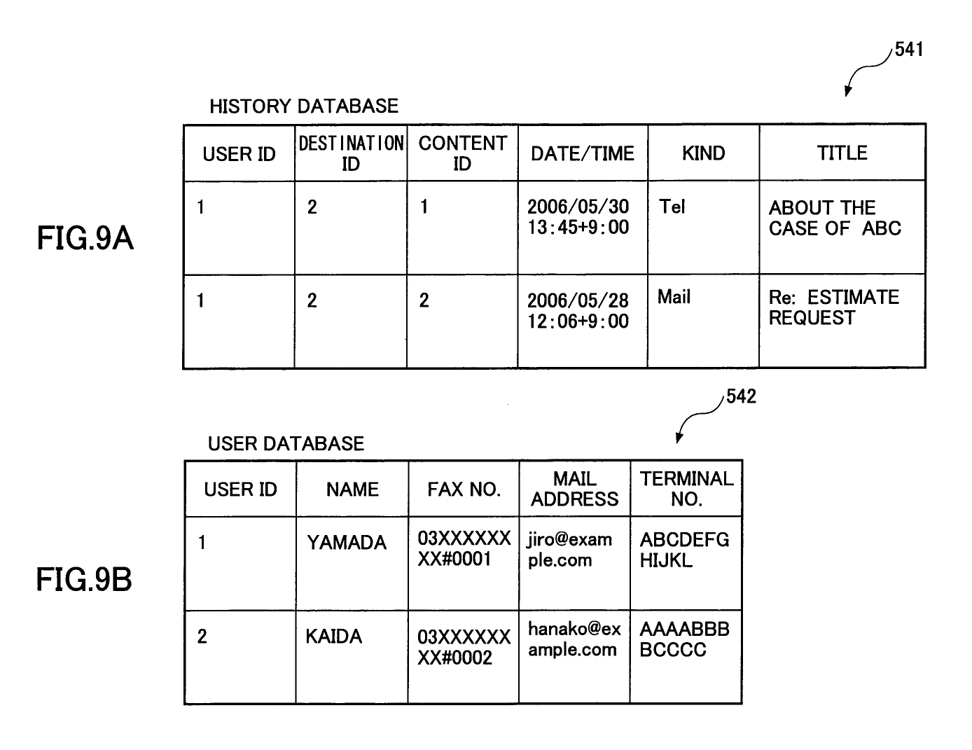

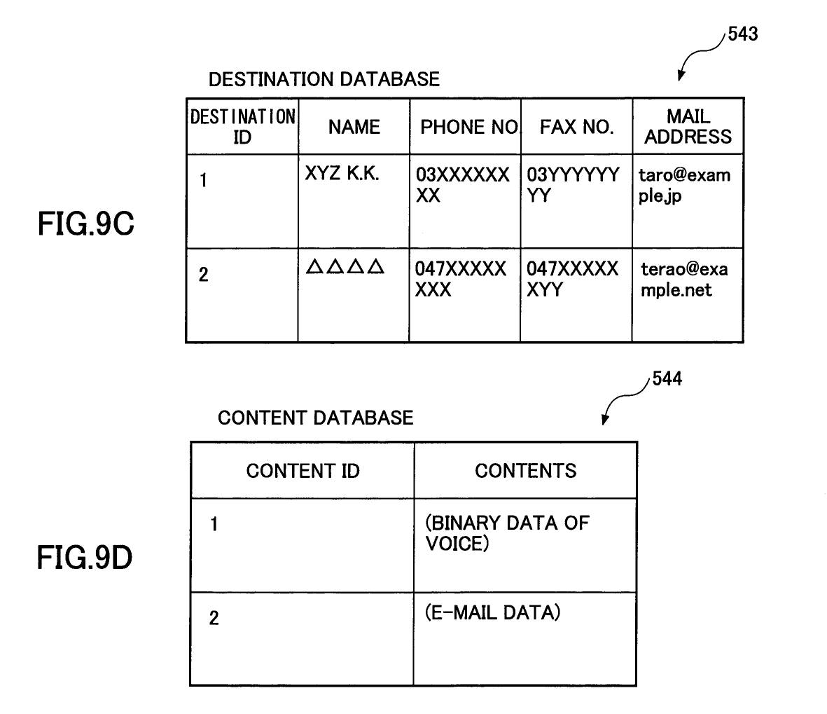

FIG. 9A to FIG. 9D show an example of a history database group 54. FIG. 9A shows an example of the history database 541, and this history database 541 includes a plurality of items, including “user ID”, “destination ID”, “content ID”, “date/time”, “kind” and “title”. FIG. 9B shows an example of the user database 542, and this user database 542 includes a plurality of items, including “user ID”, “name”, “fax number”, “mail address”, and “terminal number”.

FIG. 9C shows an example of the destination database 543, and this destination database 543 includes a plurality of items, including “destination ID”, “name”, “phone number”, “fax number” and “mail address”. FIG. 9D shows an example of the content database 544, and this content database 544 includes a plurality of items, including “content ID” and contents.

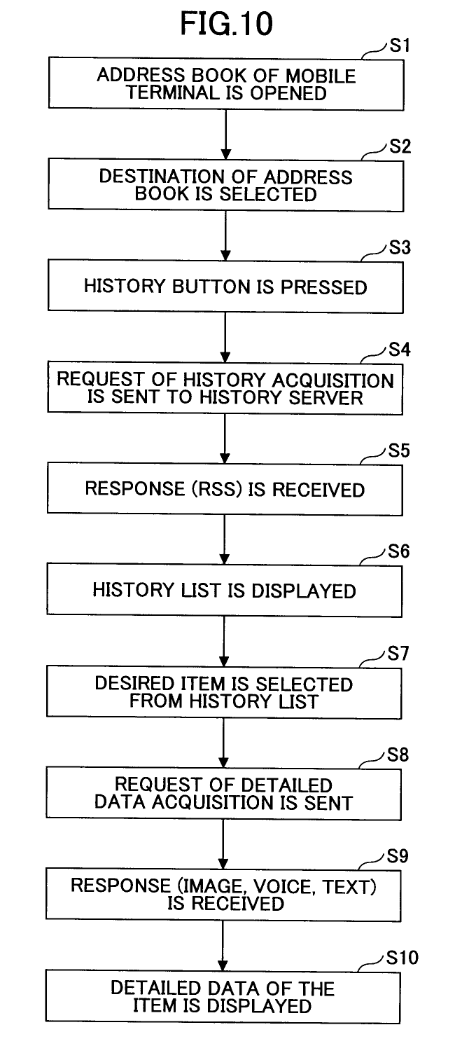

FIG. 10 is a flowchart for explaining the processing when viewing of the address book in the mobile terminal 10 is performed.

As shown in FIG. 10, when a user wants to view the history of latest exchanges with a customer, such as phone calls, faxes and mails, in a place away from the office of the user, the user opens the address book of the mobile terminal 10 (step S1), selects a destination from among the destinations of the address book (step S2), and presses a history button of the mobile terminal 10 (step S3).

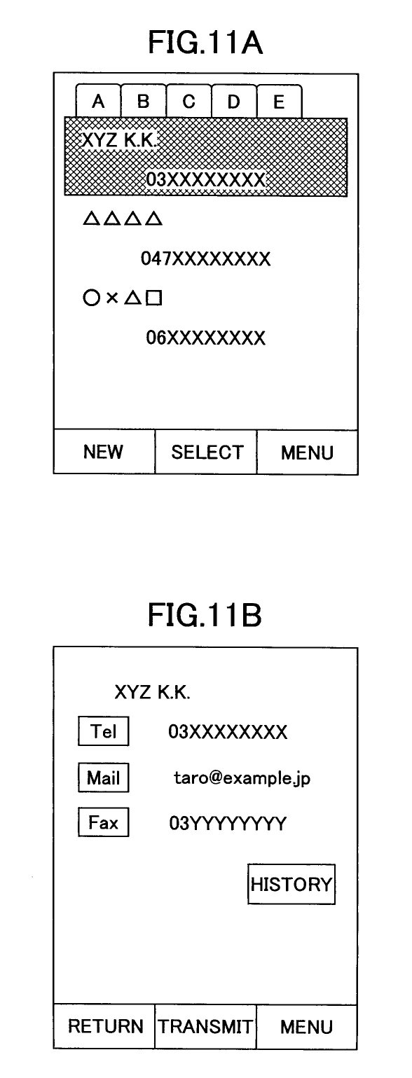

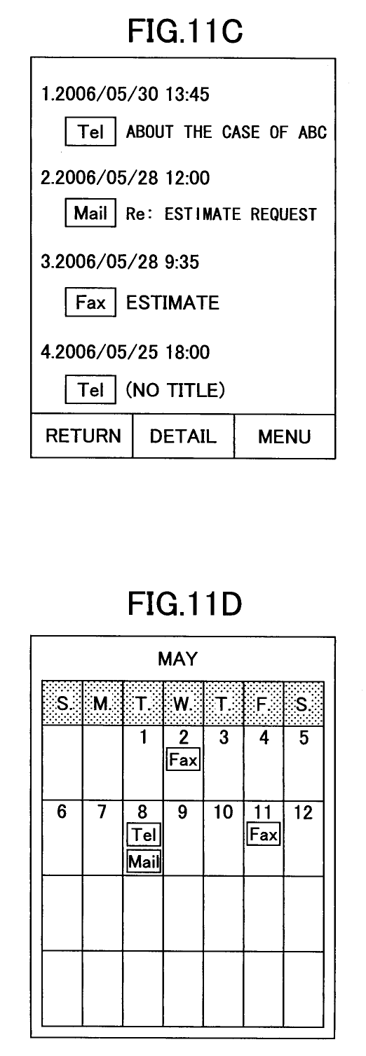

FIG. 11A to FIG. 11D show examples of display screens in the mobile terminal 10 when the address book is viewed. FIG. 11A shows the state in which the destination (the customer) is selected from the address book (the shaded portion in FIG. 11A). FIG. 11B shows the state in which the detailed data (phone number, e-mail address, fax number, etc.) of the selected destination is displayed and the history button appears on the screen.

Referring back to FIG. 10, when the history button is pressed by the user, the request of history acquisition is transmitted to the history server 5 from the mobile terminal 10 (step S4). The mobile terminal 10 receives a response including an RSS of history information from the history server 5 (step S5).

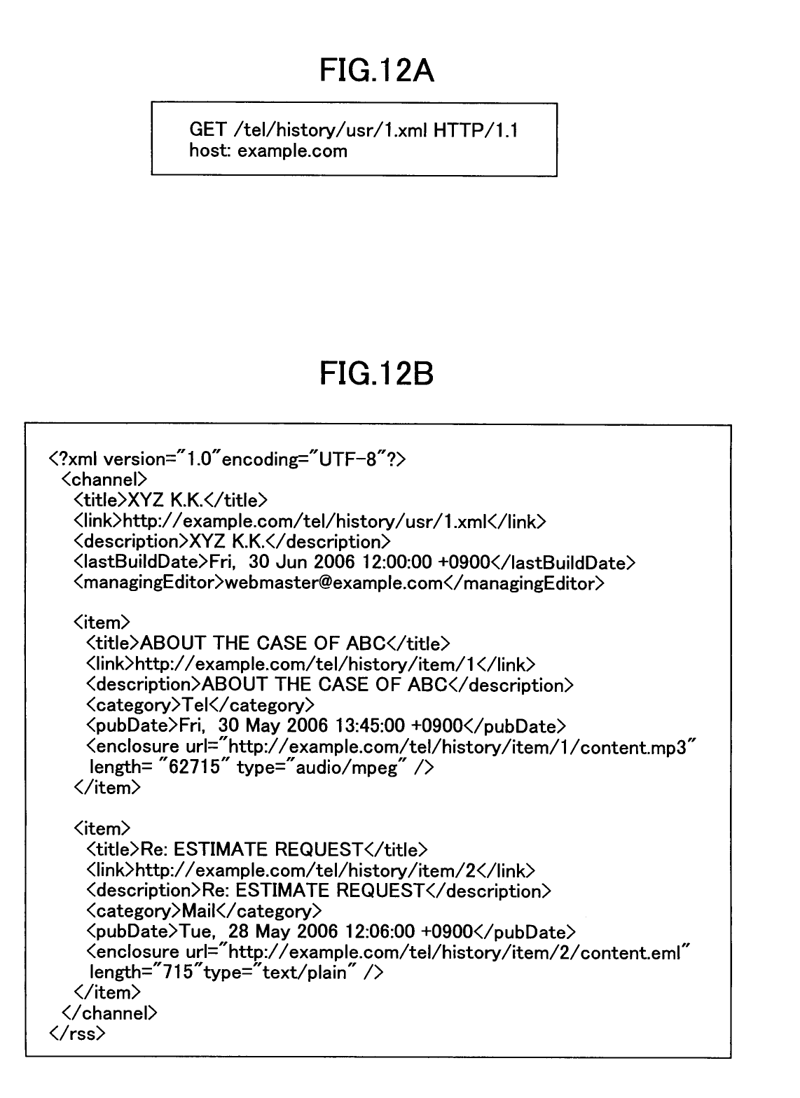

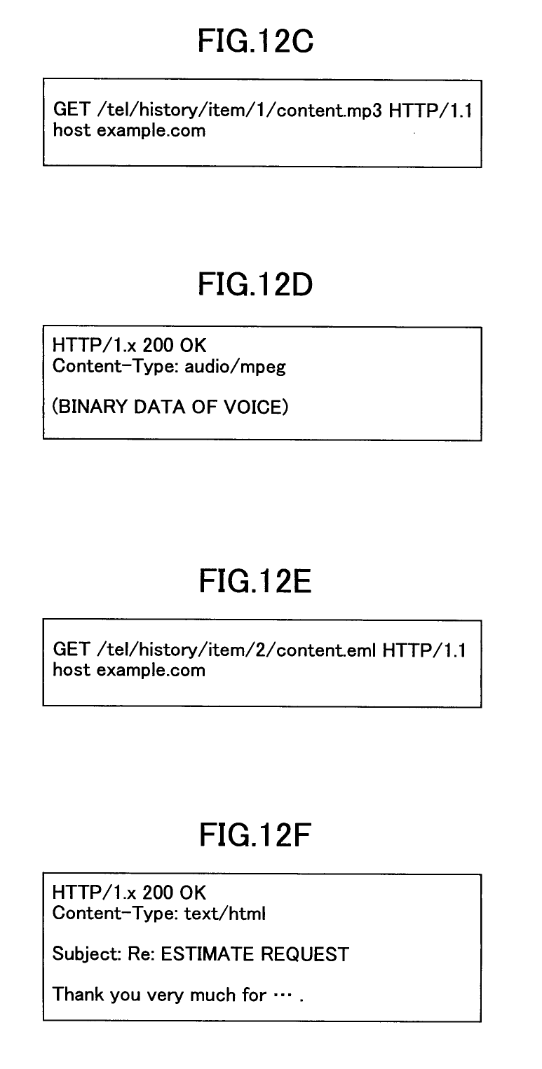

FIG. 12A to FIG. 12F show examples of RSS contained in the request and the response exchanged between the mobile terminal 10 and the history server 5. FIG. 12A shows an RSS which is contained in the request transmitted from the mobile terminal 10 to the history server 5. FIG. 12B shows an RSS which is contained in the response transmitted from the history server 5 to the mobile terminal 10. This RSS includes the history information for each item element.

Referring back to FIG. 10, a history list is displayed in the mobile terminal 10 based on the received RSS (step S6). FIG. 11C shows an example of a display screen of the history list. Alternatively, the history list may be processed in a calendar form and such a list may be displayed as shown in FIG. 11D.

Referring back to FIG. 10, when a desired item of the history list which the user wants to check its detailed information is selected from the history list (step S7), the request of detailed data acquisition with respect to the selected item is transmitted to history server 5 from the mobile terminal 10 (step S8). And the mobile terminal 10 receives a response containing any of image data, voice data and text data, from the history server 5 (step S9). FIG. 12C shows an example of a voice data acquisition request which is transmitted to the history server 5 from the mobile terminal 10, and FIG. 12D shows an example of a response which is received in that case.

FIG. 12E shows an example of a mail text data acquisition request which is transmitted to the history server 5 from the mobile terminal 10, and FIG. 12F shows an example of a response which is received in that case.

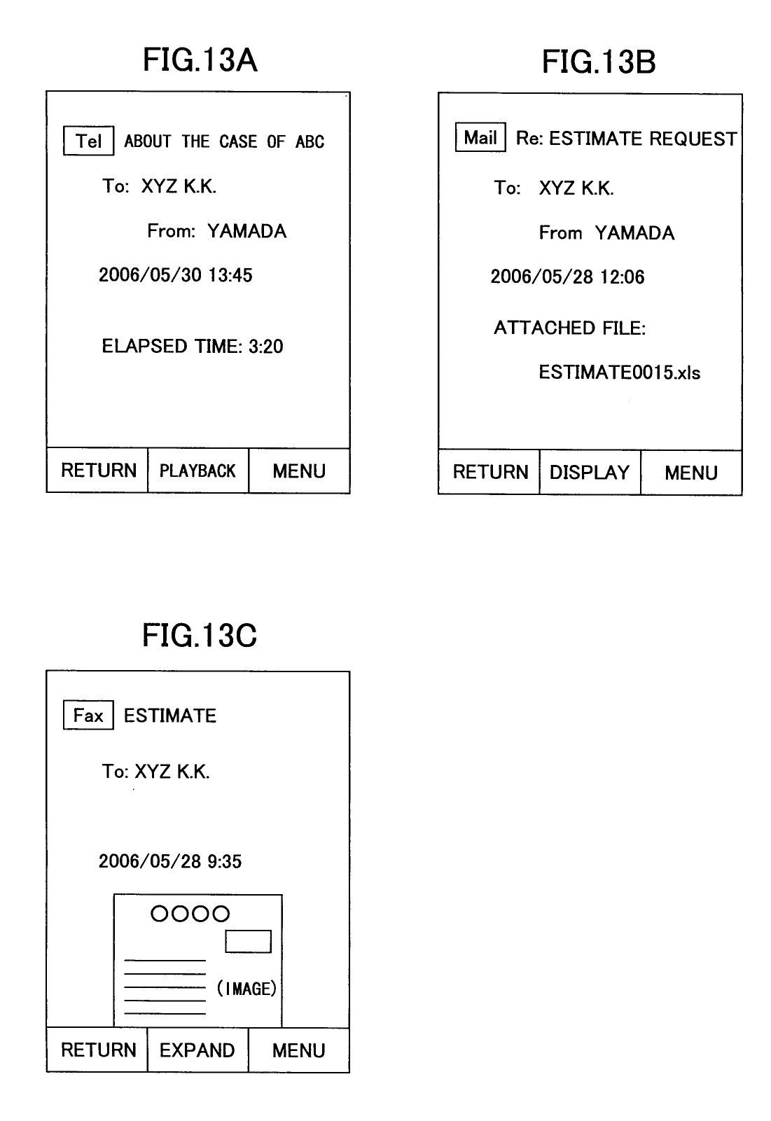

Referring back to FIG. 10, the detailed data of the selected item is displayed in the mobile terminal 10 (step S10). FIG. 13A to FIG. 13C show examples of display screens in the mobile terminal 10 when detailed item information is displayed. FIG. 13A shows an example of a display screen when detailed data of the phone call history information is selected (the phone call voice will be reproduced if the playback button is pressed). FIG. 13B shows an example of a display screen when detailed data of the e-mail history information is selected (the mail text data will be displayed if the display button is pressed). FIG. 13C shows an example of a display screen when detailed data of the fax history information is selected (the thumbnail image is displayed and the detailed image will be displayed if the expand button is pressed).

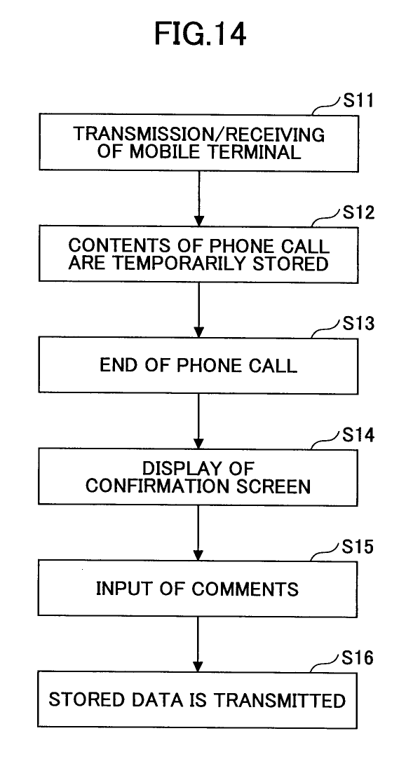

FIG. 14 is a flowchart for explaining the processing when a phone call is performed by the mobile terminal 10.

As shown in FIG. 14, when a user performs transmission or reception of a phone call in the mobile terminal 10 (step S11), the voice data of the contents of the phone call is stored in the mobile terminal 10 or the IP phone conversion server 6 (step S12).

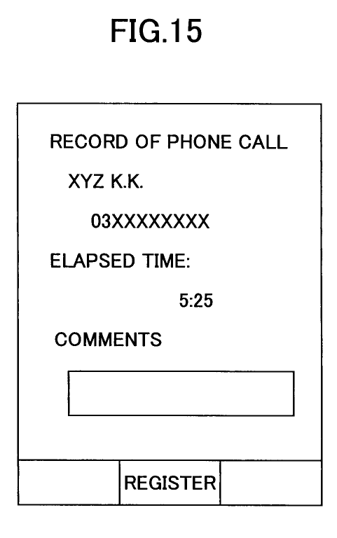

After the phone call is completed (step S13), a confirmation screen for phone call history information is displayed (step S14), and the user inputs comments (step S15). FIG. 15 shows an example of a display screen on the mobile terminal 10 after a phone call is terminated. As shown in FIG. 5, the state in which history information, including a destination name, a phone number, an elapsed time of phone call, and a box for inputting comments are displayed.

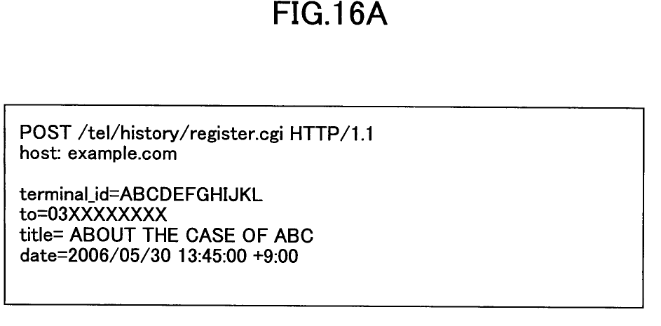

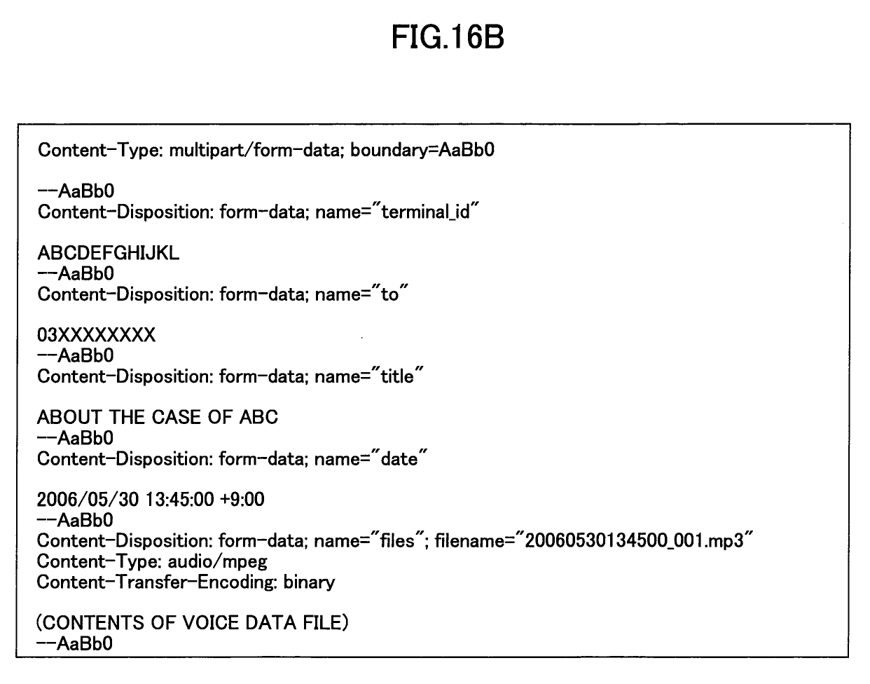

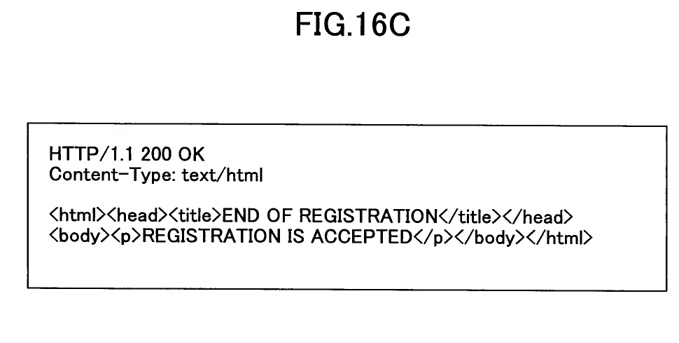

Referring back to FIG. 14, after the comments are inputted by the user, the mobile terminal 10 transmits the history data and the voice data (when the voice data is temporarily stored in the mobile terminal 10) to the history server 5 (step S16). FIG. 16A to FIG. 16C show examples of a request and a response exchanged between the mobile terminal 10 and the history server 5. FIG. 16A shows a history registration request which is transmitted from the mobile terminal 10 to the history server 5. FIG. 16B shows a description when the voice data is transmitted by a multi-part transmission. FIG. 16C shows a response which is transmitted from the history server 5 to the mobile terminal 10.

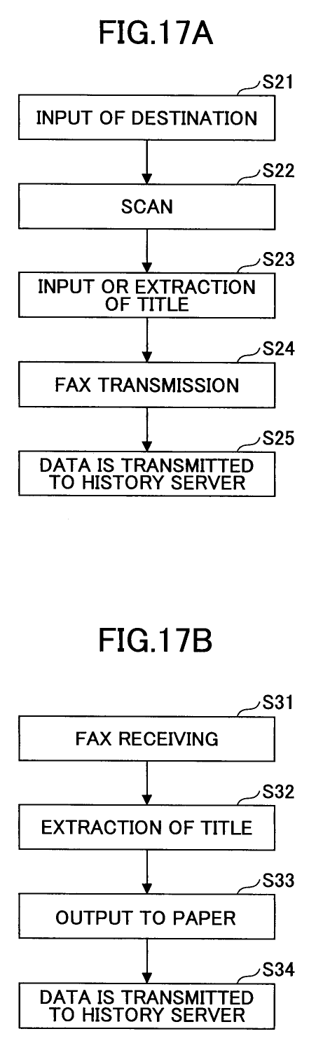

FIG. 17A and FIG. 17B are flowcharts for explaining the processing when a fax transmission is performed by the fax terminal and the processing when a fax reception is performed by the fax terminal.

Upon start of the processing shown in FIG. 17A, a user inputs a transmission destination on the fax terminal 3 (step S21). After scanning of the document being transmitted is performed (step S22), the fax terminal 3 requests the user to perform the manual input of the title or automatic extracting of the title (by an optical character reader (OCR)) (step S23). The fax terminal 3 performs fax transmission (step S24). Then, the fax terminal 3 transmits history information (including the title inputted by the user or the information obtained through the automatic extracting) to the history server 5 (step S25).

Upon start of the processing shown in FIG. 17B, the fax terminal 3 performs fax receiving (step S31). The fax terminal 3 performs automatic extracting of the title (step S32) and outputs the received image to paper (step S33). Then, the fax terminal 3 transmits history information (including the title obtained through the automatic extracting) to the history server 5 (step S34).

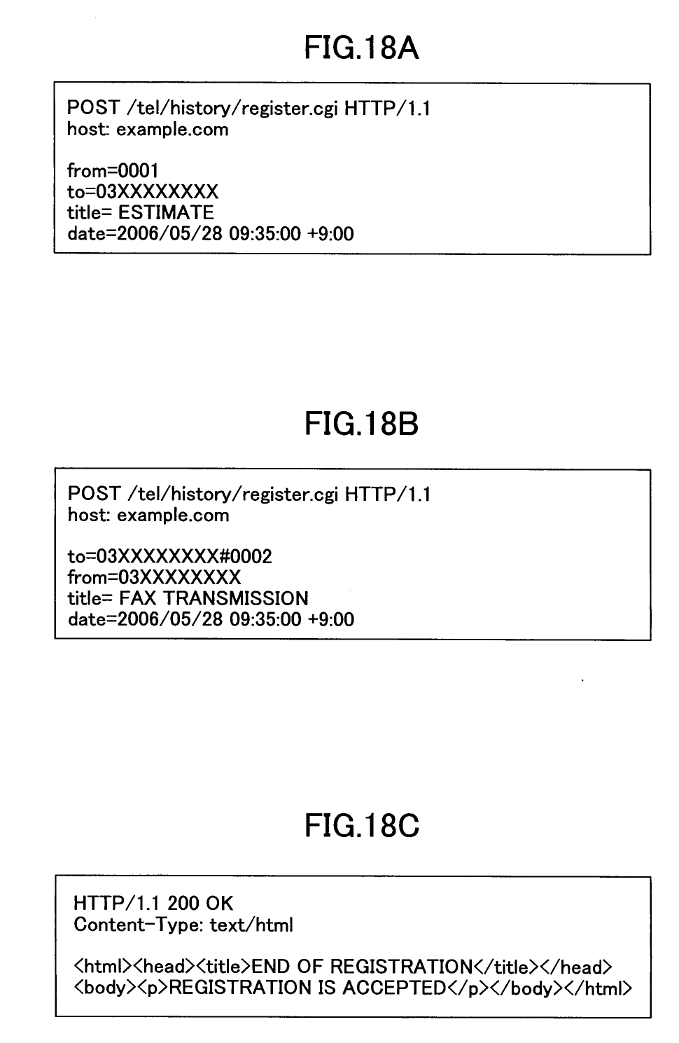

FIG. 18A to FIG. 18C show examples of a request and a response exchanged between the fax terminal 3 and the history server 5. FIG. 18A shows an example of a request for registration of fax transmission history information transmitted from the fax terminal 3 to the history server 5. FIG. 18B shows an example of a request for registration of fax receiving history information transmitted from the fax terminal 3 to the history server 5. FIG. 18C shows an example of a response to the request of FIG. 18A or FIG. 18B transmitted from the history server 5 to the fax terminal 3.

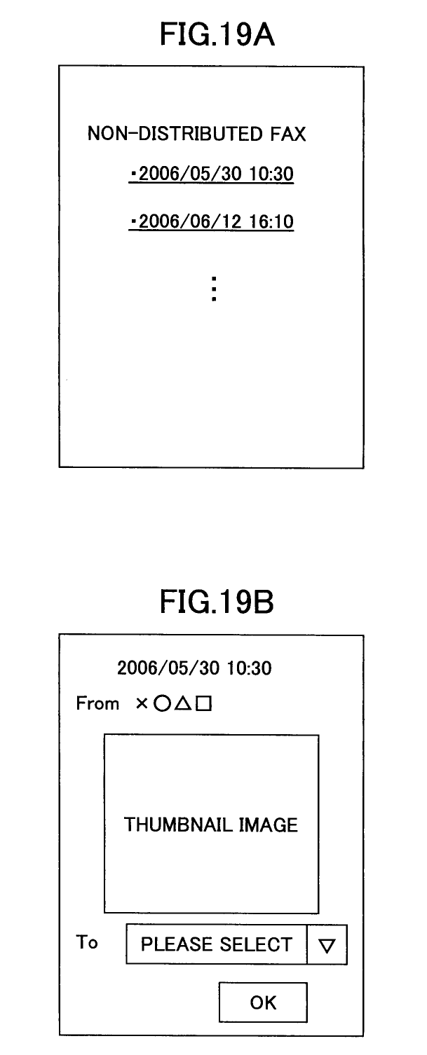

FIG. 19A and FIG. 19B show examples of display screens in the mobile terminal 10 when a fax distribution is performed. When the transmission destination cannot be detected correctly through the automatic extracting, this fax distribution is performed in order to request the user to set up the transmission destination.

If the user chooses one item from among items of the list of the non-distributed fax shown in FIG. 19A, the display screen of the fax terminal 3 is changed to a display screen of detailed data of the selected item as shown in FIG. 19B. If the user chooses one item from the registered destinations in the display screen, then the transmission destination can be set up.

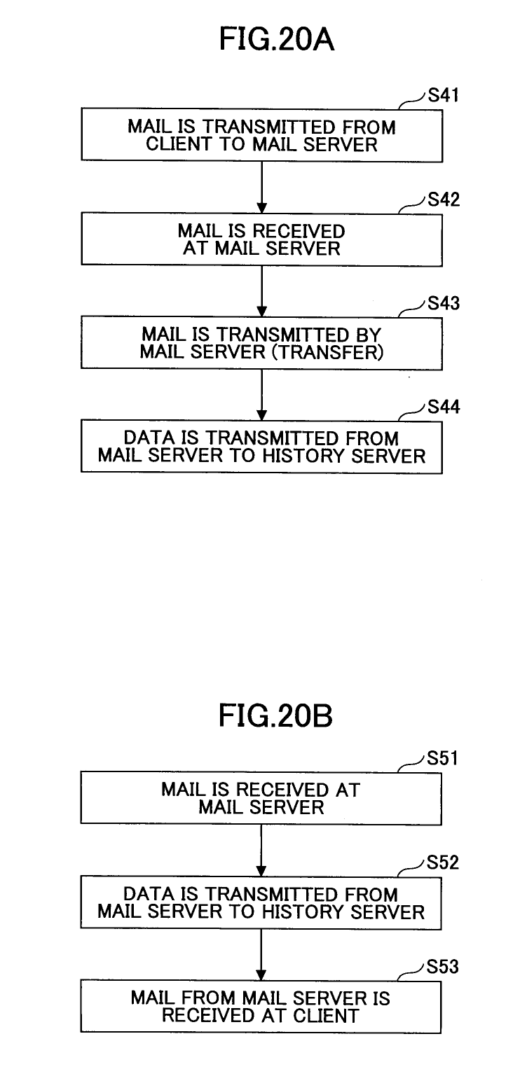

FIG. 20A and FIG. 20B are flowcharts for explaining the processing when a mail transmission is performed by the mail server and the processing when a mail reception is performed by the mail server.

As shown in FIG. 20A, when an e-mail is transmitted from the client (the PC 4 in FIG. 1) to the mail server 2 (step S41), the mail server 2 receives this e-mail (step S42) and performs e-mail transmission (transfer) (step S43). Then, the mail server 2 transmits the history information (data) to the history server 5 (step S44).

As shown in FIG. 20B, when the mail server 2 transmits an e-mail (step S51), the mail server 2 transmits the history information (data) to history server 5 (step S52). Then, the client (the PC 4 in FIG. 1) received the e-mail from the mail server 2 (step S53).

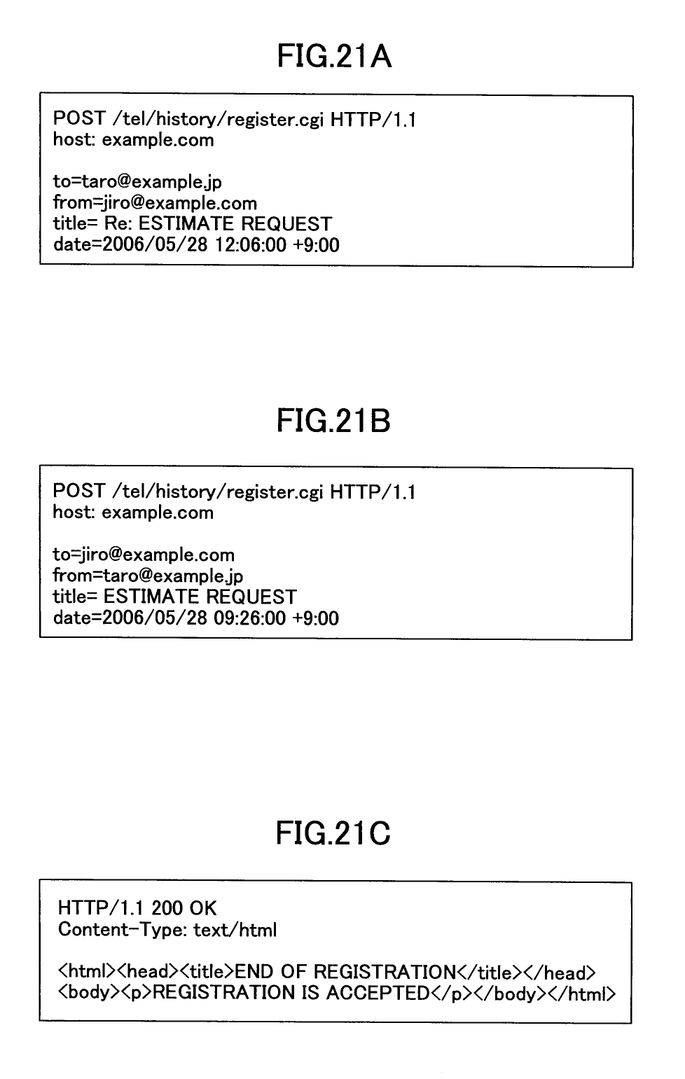

FIG. 21A, FIG. 21B and FIG. 21C show examples of a request and a response exchanged between the mail server 2 and the history server 5. FIG. 21A shows an example of a request for registration of mail transmission history information transmitted from the mail server 2 to the history server 5. FIG. 20B shows an example of a request for registration of mail receiving history information transmitted from the mail server 2 to the history server 5. FIG. 21C shows an example of a response to the request of FIG. 21A or FIG. 21B transmitted from the history server 5 to the mail server 2.

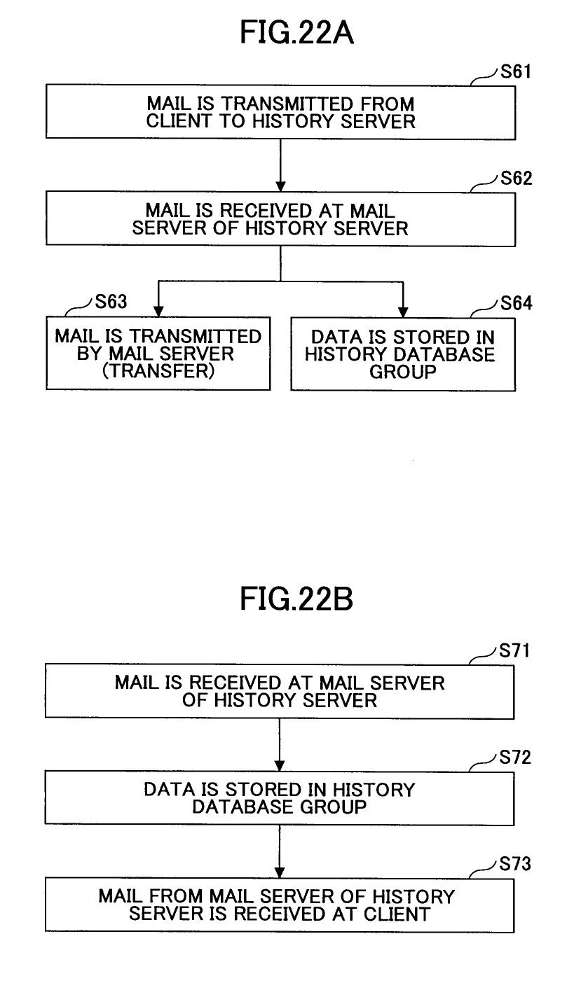

FIG. 22A and FIG. 22B are flowcharts for explaining the processing when a mail transmission is performed by the history server and the processing when a mail reception is performed by the mail server. Suppose that the history server 5 has the composition in which the mail server 2 is provided in the history server 5 as shown in FIG. 3.

As shown in FIG. 22A, when an e-mail is transmitted from the client (the PC 4 in FIG. 3) to the history server 5 (step S61), the mail server 2 of the history server 5 receives this e-mail (step S62) and performs e-mail transmission (transfer) (step S63). At the same time, the history server 5 stores the history information (data) in the history database group 54 (step S64). The e-mail transmission of the step S63 and the data storage to the history database group 54 of the step S64 may be processed in parallel simultaneously, or they may be processed sequentially.

As shown in FIG. 22B, when the mail server 2 of the history server 5 transmits an e-mail (step S71), the history server 5 stores the history information (data) in the history database group 54 (step S72). Then, the client (the PC 4 in FIG. 3) receives the e-mail from the mail server 2 of the history server 5 (step S73).

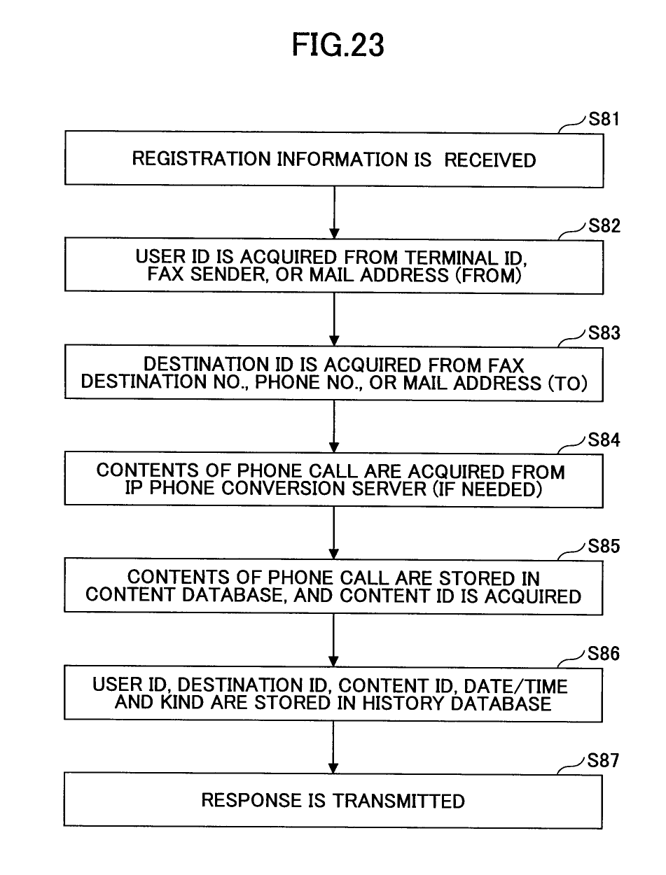

FIG. 23 is a flowchart for explaining the processing when a history registration request is received by the history server.

As shown in FIG. 23, when the history server 5 receives the information for history information registration from any of the mobile terminal 10, the mail server 2 and the fax terminal 3 (step S81), the history server 5 acquires a user ID from the terminal ID, the fax sender name or the e-mail address (step S82), and acquires a destination ID from the fax destination number, the phone number or the e-mail address (step S83).

Subsequently, the history server 5 acquires the contents of the phone call from the IP phone conversion server 6, if needed (step S84), and stores the acquired contents into the content database 544 and acquires a content ID (step S85).

Subsequently, the history server 5 stores the user ID, the destination ID, the content ID, the date/time and the kind into the history database 541 (step S86). And the history server 5 transmits a response of history registration completion to the requesting terminal (step S87).

Accordingly, the above-mentioned embodiment of the invention allows a user to view communication history with a customer in a place away from the office of the user, and the operating activities of the user can be effectively supported by the mobile terminal of the invention.

The present invention is not limited to the above-described embodiments, and variations and modifications may be made without departing from the scope of the present invention.

The present application is based on and claims the benefit of priority of Japanese patent application No. 2006-247237, filed on Sep. 12, 2006, and Japanese patent application No. 2007-220251, filed on Aug. 27, 2007, the entire contents of which are hereby incorporated by reference.

What is claimed is:

1. A mobile terminal comprising:
a destination specifying unit configured to specify a communication destination;
a server connection unit configured to connect the mobile terminal with a history server which manages communication history; and
a history information acquisition unit configured to transmit a request to the history server through the server connection unit and to acquire history information having a metadata described in a structured language and containing an update information of a communication history of the communication destination, specified by the destination specifying unit, from the history server through the server connection unit.

2. The mobile terminal according to claim 1, further comprising a registration request unit configured to request the history server to register a communication history.

3. The mobile terminal according to claim 1, further comprising:
a unit configured to display a list of items of the history information acquired from the history server; and
a unit configured to transmit a request to the history server in response to an item selected by a user from among the items of the history information in the list, so that detailed information of the history information corresponding to the selected item is acquired from the history server and displayed in the mobile terminal.

4. The mobile terminal according to claim 2, further comprising a unit configured to temporarily store call voice data in the mobile terminal.

5. The mobile terminal according to claim 4, wherein the registration request unit is configured to transmit the temporarily stored call voice data by a multi-part transmission as a part of the communication history being registered by the history server.

6. A mail server for use with the mobile terminal according to claim 1, wherein the mail server comprises a mail registration request unit configured to request the history server to register history information of e-mail transmitting and receiving.

7. A fax terminal for use with the mobile terminal according to claim 1, wherein the fax terminal comprises a fax registration request unit configured to request the history server to register history information of fax transmitting and receiving.

8. A history server comprising:
a request receiving unit configured to receive a request from a terminal;
a history information storing unit configured to store, in response to a request for registration of communication history information from the terminal, the history information; and
a response transmitting unit configured to transmit, in response to a request for acquisition of communication history information from the terminal, a response having a metadata in which the history information is described in a structured language, to the terminal.

9. The history server according to claim 8, further comprising:
a history database holding history information;
a user database holding user information;
a destination database holding destination information; and
a content database holding a main part of communication data.

10. The history server according to claim 8, further comprising a unit configured to temporarily store call voice data.

11. The history server according to claim 8, wherein the history server is provided with a mail server function, and communication history information of the mail server function is registered in the history server.

12. A history viewing management method comprising steps of:
specifying a communication destination;
connecting a mobile terminal with a history server which manages communication history;
transmitting a request to the history server through the connecting step; and
acquiring history information having a metadata described in a structured language and containing an update information of a communication history of the communication destination, specified in the specifying step, from the history server through the connecting step.

13. The history viewing management method according to claim 12, further comprising a step of requesting the history server to register a communication history.

14. The history viewing management method according to claim 12, further comprising steps of:
displaying a list of items of the history information acquired from the history server; and
transmitting a request to the history server in response to an item selected by a user from among the items of the history information in the list, so that detailed information of the history information corresponding to the selected item is acquired from the history server and displayed in the mobile terminal.
